(19) United States
(12) Patent Application Publication
(10) Pub. No.: US 2025/0285616 A1
(43) Pub. Date: Sep. 11, 2025

(54) Quantization Aware Training for Universal Speech Models with Recurrent Neural Network-Transducer Decoders

(71) Applicant: Google LLC, Mountain View, CA (US)

(72) Inventors: Oleg Rybakov, Redmond, WA (US); Dmitriy Serdiuk, Brooklyn, NY (US); Chengjian Zheng, Mountain View, CA (US)

(73) Assignee: Google LLC, Mountain View, CA (US)

(21) Appl. No.: 19/075,428

(22) Filed: Mar. 10, 2025

Related U.S. Application Data
(60) Provisional application No. 63/563,757, filed on Mar. 11, 2024.

(51) Int. Cl. G10L 15/16; G10L 15/06

(52) U.S. Cl. CPC G10L 15/16; G10L 15/063

(57) ABSTRACT

A method includes obtaining a plurality of training samples that each include audio data characterizing a corresponding speech utterance and a transcription of the corresponding speech utterance. The method also includes training an automatic speech recognition (ASR) model on the plurality of training samples, the ASR model having a recurrent neural network-transducer (RNN-T) architecture. The method also includes quantizing the trained ASR model to an integer target fixed-bit width and providing the quantized trained ASR model to a user device.

### CROSS-REFERENCE TO RELATED APPLICATIONS

This U.S. Patent Application claims priority under 35 U.S.C. § 119 (e) to U.S. Provisional Application 63/563,757, filed on Mar. 11, 2024. The disclosure of this prior application is considered part of the disclosure of this application and is hereby incorporated by reference in its entirety.

### TECHNICAL FIELD

This disclosure relates to quantization aware training for universal speech models with recurrent neural network-transducer decoders.

### BACKGROUND

End-to-end automatic speech recognition (ASR) models have seen revolutionary quality gains with the recent development of large-scale universal speech models (USM). However, the massive size of these models (e.g., several billions of parameters) makes the models expensive to deploy due to the need of considerable amounts of memory and computational units. Therefore, efficient training and model compression algorithms have become unprecedentedly important research topics.

### SUMMARY

One aspect of the disclosure provides a computer-implemented method that when executed on data processing hardware causes the data processing hardware to perform operations that include obtaining a plurality of training samples that each include audio data characterizing a corresponding speech utterance and a transcription of the corresponding speech utterance. The operations also include training an automatic speech recognition (ASR) model on the plurality of training samples. The ASR model includes a recurrent neural network-transducer (RNN-T) architecture. The operations also include quantizing the trained ASR model to an integer target fixed-bit width and providing the quantized trained ASR model to a user device.

Implementations of the disclosure may include one or more of the following optional features. In some implementations, quantizing the trained ASR model includes quantizing, using per-channel asymmetrical quantization with scale backpropagation, the trained ASR model to the target fixed-bit width, the target fixed-bit width equal to two. In another implementation, quantizing the trained ASR model includes quantizing, using per-channel asymmetrical quantization with scale backpropagation, clipping, and sub-channel split, the trained ASR model to the target fixed-bit width, the target fixed-bit width equal to two. In yet another implementation, quantizing the trained ASR model includes quantizing, using absolute max binarization, the trained ASR model to the target fixed-bit width, the target fixed-bit width equal to one. In yet another implementation, quantizing the trained ASR model includes subtracting a per channel mean value from a plurality of weights of the trained ASR model to provide a plurality of scaled weights and binarizing the plurality scaled weights to the target fixed-bit width, the target fixed-bit width equal to one. In yet another implementation, quantizing the trained ASR model includes increasing a number of channels in a plurality of input weights of the trained ASR model by splitting the plurality of input weights into sub-channels, subtracting a per sub-channel mean value from the plurality of input weights of the trained ASR model to provide a plurality of scaled weights, binarizing the plurality of scaled weights; de-quantizing, using fake quantization aware training, the binarized scaled weights by multiplying the binarized scaled weights by a scaling factor to provide de-quantized weights, re-shaping the de-quantized weights to a same shape as a shape of the plurality of input weights, and computing an einsum over an input activation applied to the re-shaped de-quantized weights to quantize the trained ASR model to the target fixed-bit width, the target fixed-bit width equal to one.

In some examples, obtaining the plurality of training samples includes receiving training data that includes a corpus of transcribed non-synthetic speech utterances each paired with a corresponding transcription and a corpus of un-transcribed non-synthetic speech utterances. Each un-transcribed non-synthetic speech utterance is not paired with a corresponding transcription. In these examples, a teacher ASR model is trained on the corpus of transcribed non-synthetic speech utterances to teach the teacher ASR model to learn how to predict the corresponding transcriptions from the non-synthetic speech utterances and the trained teacher model is used to process the corpus of transcribed non-synthetic speech utterances and the corpus of un-transcribed non-synthetic speech utterances to predict corresponding pseudo ground-truth labels.

In some implementations, the ASR model includes an audio encoder and a decoder. The decoder includes a prediction network and a joint network. In these implementations, quantizing the ASR model may include quantizing the audio encoder and not quantizing the decoder. Additionally, the audio encoder may include a plurality of self-attention layers that each include a multi-headed attention mechanism. The self-attention layers may include conformer layers or transformer layers. Notably, the speech utterances and transcriptions of the plurality of training samples may span multiple different languages such that the trained ASR model includes a multilingual ASR model.

Another aspect of the disclosure provides a system that includes data processing hardware and memory hardware storing instructions that when executed on the data processing hardware causes the data processing hardware to perform operations that include obtaining a plurality of training samples that each include audio data characterizing a corresponding speech utterance and a transcription of the corresponding speech utterance. The operations also include training an automatic speech recognition (ASR) model on the plurality of training samples. The ASR model includes a recurrent neural network-transducer (RNN-T) architecture. The operations also include quantizing the trained ASR model to an integer target fixed-bit width and providing the quantized trained ASR model to a user device.

This aspect of the disclosure may include one or more of the following optional features. In some implementations, quantizing the trained ASR model includes quantizing, using per-channel asymmetrical quantization with scale backpropagation, the trained ASR model to the target fixed-bit width, the target fixed-bit width equal to two. In another implementation, quantizing the trained ASR model includes quantizing, using per-channel asymmetrical quantization with scale backpropagation, clipping, and sub-channel split, the trained ASR model to the target fixed-bit width, the target fixed-bit width equal to two. In yet another implementation, quantizing the trained ASR model includes quantizing, using absolute max binarization, the trained ASR model to the target fixed-bit width, the target fixed-bit width equal to one. In yet another implementation, quantizing the trained ASR model includes subtracting a per channel mean value from a plurality of weights of the trained ASR model to provide a plurality of scaled weights and binarizing the plurality scaled weights to the target fixed-bit width, the target fixed-bit width equal to one. In yet another implementation, quantizing the trained ASR model includes increasing a number of channels in a plurality of input weights of the trained ASR model by splitting the plurality of input weights into sub-channels, subtracting a per sub-channel mean value from the plurality of input weights of the trained ASR model to provide a plurality of scaled weights, binarizing the plurality of scaled weights; de-quantizing, using fake quantization aware training, the binarized scaled weights by multiplying the binarized scaled weights by a scaling factor to provide de-quantized weights, re-shaping the de-quantized weights to a same shape as a shape of the plurality of input weights, and computing an einsum over an input activation applied to the re-shaped de-quantized weights to quantize the trained ASR model to the target fixed-bit width, the target fixed-bit width equal to one.

In some examples, obtaining the plurality of training samples includes receiving training data that includes a corpus of transcribed non-synthetic speech utterances each paired with a corresponding transcription and a corpus of un-transcribed non-synthetic speech utterances. Each un-transcribed non-synthetic speech utterance is not paired with a corresponding transcription. In these examples, a teacher ASR model is trained on the corpus of transcribed non-synthetic speech utterances to teach the teacher ASR model to learn how to predict the corresponding transcriptions from the non-synthetic speech utterances and the trained teacher model is used to process the corpus of transcribed non-synthetic speech utterances and the corpus of un-transcribed non-synthetic speech utterances to predict corresponding pseudo ground-truth labels.

In some implementations, the ASR model includes an audio encoder and a decoder. The decoder includes a prediction network and a joint network. In these implementations, quantizing the ASR model may include quantizing the audio encoder and not quantizing the decoder. Additionally, the audio encoder may include a plurality of self-attention layers that each include a multi-headed attention mechanism. The self-attention layers may include conformer layers or transformer layers. Notably, the speech utterances and transcriptions of the plurality of training samples may span multiple different languages such that the trained ASR model includes a multilingual ASR model.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for performing speech recognition.

FIG. 2 is a schematic view of a Recurrent Neural Network-Transducer (RNN-T) model architecture.

FIGS. 3A and 3B are schematic views of an example training initialization process for training a teacher model to learn how to predict ground-truth pseudo labels from speech utterances

FIG. 4 is a schematic view of an example training process for training and quantizing a speech recognition model.

FIG. 5 is an example algorithm of a absolute mean binarization technique.

FIG. 6 is a schematic view of an example of the training process of FIG. 4 applying a combination of sub-channel split with absolute mean binarization.

FIG. 6 is an example algorithm of the training process of FIG. 4.

FIG. 7 is a flowchart of an example arrangement of operations for a method of training and quantizing a speech recognition model.

FIG. 8 is a schematic view of an example computing device that may be used to implement the systems and methods described herein.

Like reference symbols in the various drawings indicate like elements.

### DETAILED DESCRIPTION

End-to-end automatic speech recognition (ASR) models have seen revolutionary quality gains with the recent development of large-scale universal speech models (USM). However, the massive size of these models (e.g., several billions of parameters) makes the models expensive to deploy due to the need of considerable amounts of memory and computational units. Therefore, efficient training and model compression algorithms have become unprecedentedly important research topics.

More recently, with the rapid emergence of large-scale datasets and high-capacity data processing hardware, such as graphics processing units (GPUs) and tensor processing units (TPUs), self-supervised learned (SSL) ASR models see a trend of growing larger in size by scaling convention SSL ASR models up in order to capture multi-domain and multi-lingual distributions. As such, these SSL ASR models can serve as universal foundational models for most of speech processing tasks. However, as these SSL ASR models are expensive to deploy due to their massive size, efficient training and model compression algorithms have become unprecedentedly important topics of research.

Quantization is a technique to reduce the computational and memory costs of ASR models by representing the weights and/or activations with lower precision data types (e.g., and 8-bit integer) instead of a conventional 32-bit floating point value. However, one of the drawbacks of such a technique is a performance decrease when the amount of training data (e.g., millions of hours of speech) the model is trained on increases. Sparsity is another technique for reducing the computational and memory costs of ASR models. When using sparsity, nodes are pruned based on entropy of weights and node activity. Combining quantization with sparsity is another technique to reduce computational and memory costs of USMs by using a sparsity mask to prune weights of the USM model and then quantizing the weights of the USM model with 4-bits or 2-bits. However, the resulting USM with 2-bits weights quantization from the combined quantization with sparsity technique suffers accuracy drops by 3× in terms of word error rate (WER). There are significant challenges with respect to WER degradation for models with 1-bit weights quantization (binarization).

Implementations herein are directed toward training a USM model having a recurrent neural network-transducer (RNN-T) architecture by using weights only binarization techniques to achieve model size reduction without sacrificing large degradations in accuracy. While 4-bit quantization is generally quality-neutral for most ASR models, the effectiveness of ASR models with 2-bit weights quantization depends on the model size and data size. Namely, as USMs may include over a billion parameters and are trained on millions of hours of speech data, performing quantization aware training to achieve 2-bit or less weights quantization can result in these models having undesirable WER degradation. For example, a USM model having a Connectionist Temporal Classification (CTC) decoder and trained using native quantization aware and sparsity aware training to achieve 2-bit weights quantization has been shown to suffer an accuracy drop of 3× in terms of WER. By contrast, specific implementations disclosed herein apply weights only binarization for training the USM RNN-T model by combining absolute mean binarization with sub-channel quantization to reduce the size of the USM RNN-T model by 6.2% from its original model size while only increasing a mean WER by 1.9% compared to a float baseline model. Notably, techniques disclosed herein that use absolute mean binarization do so without weights centralization, thereby simplifying model quantization without impacting model accuracy in comparison to quantization techniques with weights centralization.

The conventional CTC-based USM model is a single large-scale model capable of performing ASR on a multitude of languages (e.g., 300 languages) that uses an audio encoder having a plurality multi-head attention layers and uses a CTC loss during training. A trainable language embedding is injected as the first token to the encoder, enabling the model to handle approximately 300 languages. Audio encodings output from the audio encoder are then fed into the CTC decoder for predicting speech recognition results. The training procedure for the USM CTC model involves a complex four-step process in which a 600 million parameter USM CTC is initially trained on a small supervised dataset to provide a teacher model for producing qauadeo labels on both supervised and unsupervised datasets during at the first step, and the audio encoder is pretrained using BERT-based Speech pre-Training with Random-projection Quantizer (BEST-RQ) for self-supervised learning at the second step. At the third step, the full USM CTC model is trained using the pseudo labels produced by the teacher model from the supervised and unsupervised datasets in the first step. Finally, the fourth step includes fine-tuning the USM CTC model with task-specific data to enhance performance.

By contrast, implementations herein are directed toward simplifying the training of the CTC-based USM model by using an RNN-T decoder in place of the CTC decoder and using an RNN-T loss for training the USM RNN-T model. As the RNN-T loss is known to have higher performance than the CTC loss, the training procedure for training the USM RNN-T model is able to exclude the BEST-RQ pre-training and fine-tuning steps (e.g., Steps 2 and 4) used in the CTC-based USM model training procedure. As such, implementations herein are directed toward a training procedure that only applies two steps for training the USM RNN-T model to provide 2-bit weights quantization at only a 1.4% WER degradation, as opposed to the 3× increase in WER degradation shown by the USM CTC-based model trained using the four-step process.

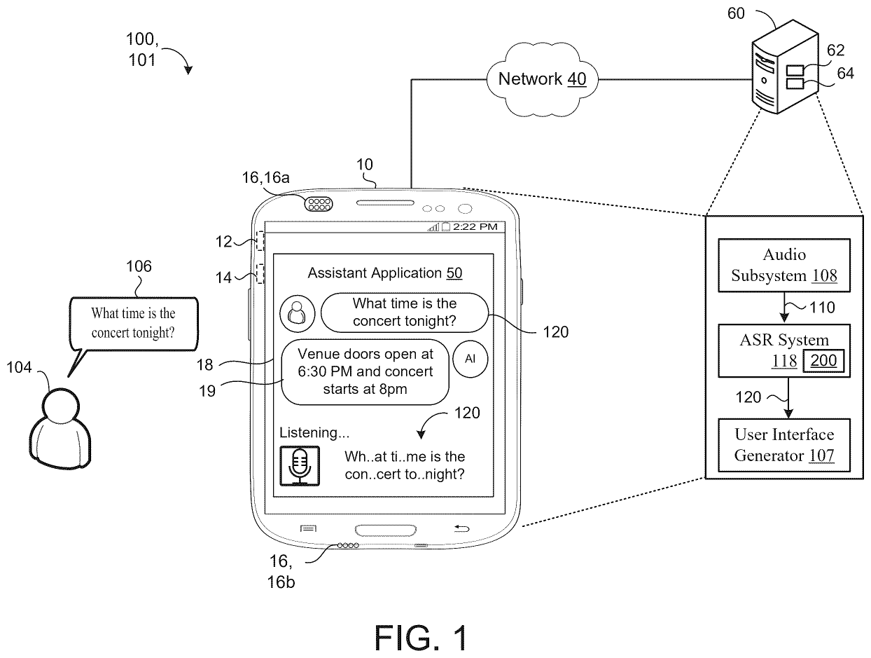

FIG. 1 is an example of a system 100 operating in a speech environment 101. In the speech environment 101, a user's 104 manner of interacting with a computing device, such as a user device 10, may be through voice input. The user device 10 (also referred to generally as a device 10) is configured to capture sounds (e.g., streaming audio data) from one or more users 104 within the speech environment 100. Here, the streaming audio data may refer to a spoken utterance 106 by the user 104 that functions as an audible query, a command for the device 10, or an audible communication captured by the device 10. Speech-enabled systems of the device 10 may field the query or the command by answering the query and/or causing the command to be performed/fulfilled by one or more downstream applications.

The user device 10 may correspond to any computing device associated with a user 104 and capable of receiving audio data. Some examples of user devices 10 include, but are not limited to, mobile devices (e.g., mobile phones, tablets, laptops, etc.), computers, wearable devices (e.g., smart watches), smart appliances, internet of things (IoT) devices, vehicle infotainment systems, smart displays, smart speakers, etc. The user device 10 includes data processing hardware 12 and memory hardware 14 in communication with the data processing hardware 12 and storing instructions, that when executed by the data processing hardware 12, causes the data processing hardware 12 to perform one or more operations. The user device 10 further includes an audio system 16 with an audio capture device (e.g., microphone) 16, 16a for capturing and converting spoken utterances 106 within the speech environment 100 into electrical signals and a speech output device (e.g., a speaker) 16, 16b for communicating an audible audio signal (e.g., as output audio data from the device 10). While the user device 10 implements a single audio capture device 16a in the example shown, the user device 10 may implement an array of audio capture devices 16a without departing from the scope of the present disclosure, whereby one or more capture devices 16a in the array may not physically reside on the user device 10, but be in communication with the audio system 16

In the speech environment 100, an automated speech recognition (ASR) system 118 includes an ASR model 200 (such as an ASR model having a recurrent neural network-transducer (RNN-T model architecture or other transducer model/multi-pass model) that resides on the user device 10 of the user 104 and/or on a remote computing device 60 (e.g., one or more remote servers of a distributed system executing in a cloud-computing environment) in communication with the user device 10 via a network 40. The remote computing device 60 is equipped with data processing hardware 62 and memory hardware 64. The user device 10 and/or the remote computing device 60 also includes an audio subsystem 108 configured to receive the utterance 106 spoken by the user 104 and captured by the audio capture device 16a, and convert the utterance 106 into a corresponding digital format associated with input acoustic frames 110 capable of being processed by the ASR system 118. In the example shown, the user speaks a respective utterance 106 and the audio subsystem 108 converts the utterance 106 into corresponding audio data (e.g., acoustic frames) 110 for input to the ASR system 118. Thereafter, the model 200 receives, as input, the audio frames 110 (i.e., audio data) corresponding to the utterance 106, and generates/predicts, as output, a corresponding transcription 120 (e.g., speech recognition result/hypothesis) of the utterance 106.

The user device 10 and/or the remote computing device 60 also executes a user interface generator 107 configured to present a representation of the transcription 120 of the utterance 106 to the user 104 of the user device 10. As described in greater detail below, the user interface generator 107 may display the speech recognition results 120 in a streaming fashion. In some configurations, the transcription 120 output from the ASR system 118 is processed, e.g., by a natural language understanding (NLU) module executing on the user device 10 or the remote computing device 60, to execute a user command/query specified by the utterance 106. Additionally or alternatively, a text-to-speech system (not shown) (e.g., executing on any combination of the user device 10 or the remote computing device 60) may convert the transcription into synthesized speech for audible output by the user device 10 and/or another device.

In the example shown, the user 104 interacts with a program or application 50 (e.g., the digital assistant application 50) of the user device 10 that uses the ASR system 118. For instance, FIG. 1 depicts the user 104 communicating with the digital assistant application 50 and the digital assistant application 50 displaying a digital assistant interface 18 on a screen of the user device 10 to depict a conversation between the user 104 and the digital assistant application 50. In this example, the user 104 asks the digital assistant application 50, “What time is the concert tonight?” This question from the user 104 is a spoken utterance 106 captured by the audio capture device 16a and processed by the audio systems 16 of the user device 10. In this example, the audio subsystem 108 receives the spoken utterance 106 and converts it into acoustic frames 110 for input to the ASR system 118.

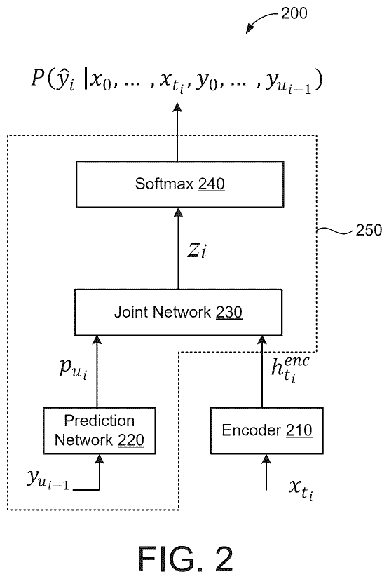

Referring to FIG. 2, an example frame alignment-based transducer model 200 includes a Recurrent Neural Network-Transducer (RNN-T) model architecture which adheres to latency constrains associated with interactive applications. The use of the RNN-T model architecture is exemplary, and the frame alignment-based transducer model 200 may include other architectures such as transformer-transducer and conformer-transducer model architectures among others. The RNN-T model 200 provides a small computational footprint and utilizes less memory requirements than conventional ASR architectures, making the RNN-T model architecture suitable for performing speech recognition entirely on the user device 102 (e.g., no communication with a remote server is required). The RNN-T model 200 includes an encoder network 210 and a decoder 250 that includes a prediction network 220 and a joint network 230. The encoder network 210, which is roughly analogous to an acoustic model (AM) in a traditional ASR system, includes a stack of multi-head attention layers (e.g., Conformer or Transformer layers) or a recurrent network of stacked Long Short-Term Memory (LSTM) layers. For instance, the encoder reads a sequence of d-dimensional feature vectors (e.g., acoustic frames 110 (FIG. 1)) x=(x₁, x₂, . . . , x_{T}), where xᵢ∈R_{d}, and produces at each output step a higher-order feature representation. This higher-order feature representation is denoted as h₁^{enc}, . . . , h_{T}^{enc}.

Similarly, the prediction network 220 is also an LSTM network, which, like a language model (LM), processes the sequence of non-blank symbols output by a final Softmax layer 240 so far, y₀, . . . , yᵤᵢ₋₁, into a dense representation pᵤ_{ᵢ}. Finally, with the RNN-T model architecture, the representations produced by the encoder and prediction/decoder networks 210, 220 are combined by the joint network 230. The prediction network 220 may be replaced by an embedding look-up table to improve latency by outputting looked-up sparse embeddings in lieu of processing dense representations. The joint network then predicts P(yᵢ|xₜ_{ᵢ}, y₀, . . . , yᵤ_{ᵢ₋₁}), which is a distribution over the next output symbol. Stated differently, the joint network 230 generates, at each output step (e.g., time step), a probability distribution over possible speech recognition hypotheses. Here, the “possible speech recognition hypotheses” correspond to a set of output labels each representing a symbol/character in a specified natural language. For example, when the natural language is English, the set of output labels may include twenty-seven (27) symbols, e.g., one label for each of the 26-letters in the English alphabet and one label designating a space. Accordingly, the joint network 230 may output a set of values indicative of the likelihood of occurrence of each of a predetermined set of output labels. This set of values can be a vector and can indicate a probability distribution over the set of output labels. In some cases, the output labels are graphemes (e.g., individual characters, and potentially punctuation and other symbols), but the set of output labels is not so limited. For example, the set of output labels can include wordpieces, phonemes, and/or entire words, in addition to or instead of graphemes. The output distribution of the joint network 230 can include a posterior probability value for each of the different output labels. Thus, if there are 100 different output labels representing different graphemes or other symbols, the output y, of the joint network 230 can include 100 different probability values, one for each output label. The probability distribution can then be used to select and assign scores to candidate orthographic elements (e.g., graphemes, wordpieces, and/or words) in a beam search process (e.g., by the Softmax layer 240) for determining the transcription 120.

The Softmax layer 240 may employ any technique to select the output label/symbol with the highest probability in the distribution as the next output symbol predicted by the RNN-T model 200 at the corresponding output step. In this manner, the RNN-T model 200 does not make a conditional independence assumption, rather the prediction of each symbol is conditioned not only on the acoustics but also on the sequence of labels output so far. The RNN-T model 200 does assume an output symbol is independent of future acoustic frames 110, which allows the RNN-T model to be employed in a streaming fashion.

In some examples, the encoder network (i.e., audio encoder) 210 of the RNN-T model 200 includes a stack of multi-head attention layers/blocks with self-attention mechanisms, such as conformer layers/blocks. In some configurations, the audio encoder 210 includes 16 conformer layers/blocks. In some examples, the relative attention in each self-attention layer is equal to 12 attention heads. Here, each conformer block includes a series of multi-headed self attention, depth wise convolution and feed-forward layers. The stack of self-attention layers/blocks may include transformer layers/blocks in other examples. The prediction network 220 may have three 2,048-dimensional LSTM layers, each of which is also followed by 640-dimensional projection layer. Alternatively, the prediction network 220 may include a stack of transformer or conformer blocks, or an embedding look-up table in lieu of LSTM layers. Finally, the joint network 230 may also have 640 hidden units. The Softmax layer 240 may be composed of a unified word piece or grapheme set that is generated using all unique word pieces or graphemes in a plurality of training data sets. The vocabulary size of the decoder 250 may be 16,384 word pieces.

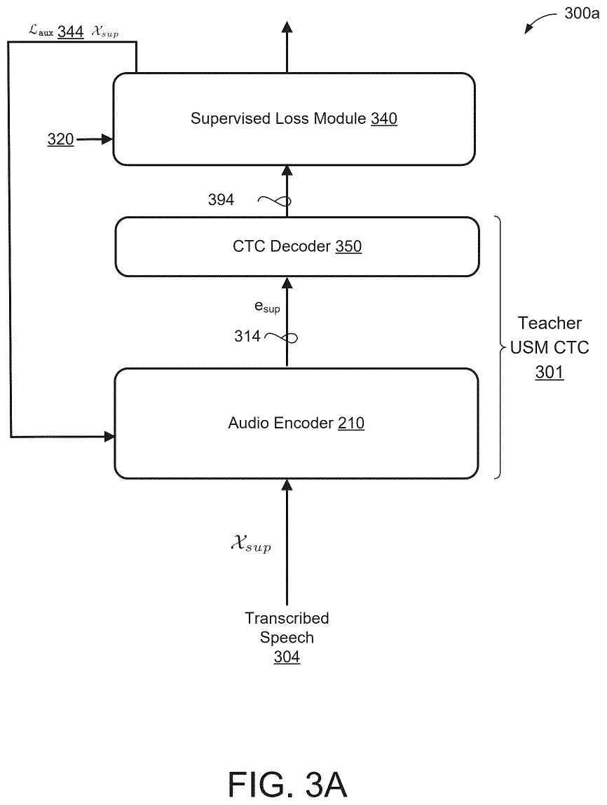

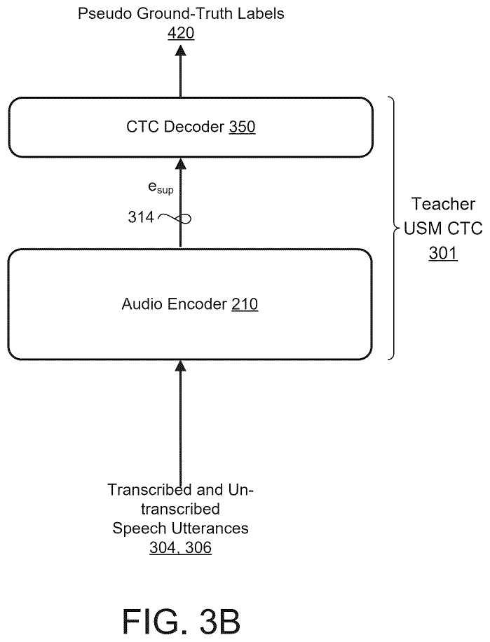

FIGS. 3A and 3B illustrate an example training initialization process 300 for training a teacher USM CTC model 301 to learn how to predict ground-truth labels 420 for supervised and unsupervised training sets that a training process 400 (FIG. 4) uses to apply quantization aware training for the ASR model 200 including the USM RNN-T model architecture. The teacher USM CTC model 301 includes the audio encoder 210 and a CTC decoder 350. The teacher USM CTC model 301 may include about 600 million parameters. For simplicity, the training initialization process 300 includes a supervised training part 300a (FIG. 3A) for training the teacher USM CTC model 350 and a label prediction part 300b (FIG. 3B) for predicting pseudo ground-truth labels 420 from both un-transcribed speech utterances 306 pertaining to the unsupervised training dataset and transcribed speech utterances 304 pertaining to the supervised training dataset. The transcribed-speech utterances 306 belong to a corpus of transcribed non-synthetic speech utterances that are each paired with a corresponding transcription 320. The corresponding transcriptions 320 may be labeled by human transcribers. The un-transcribed speech utterances 304 belong to a corpus of un-transcribed non-synthetic speech utterances that are not paired with corresponding transcriptions. The total length of the corpus of transcribed non-synthetic speech utterances 304 may be drastically shorter than the total length of the corpus of un-transcribed non-synthetic speech utterances 304. For instance, the corpus of transcribed non-synthetic speech utterances 304 may include about 680,000 hours of speech spanning 56 different languages while the corpus of un-transcribed non-synthetic speech utterances 306 may include about 4.2 million hours of speech spanning 75 different languages.

Referring to FIG. 3A, in some implementations, the audio encoder 210 includes a Conformer encoder including a stack of conformer blocks each of which includes a series of multi-headed self-attention, depth wise convolution, and feed-forward layers. Alternatively, the audio encoder 210 may include another type of encoder having a stack of self-attention layers/blocks, such as a transformer encoder. The Conformer encoder 210 can naturally be split into a feature encoder, including a convolution subsampling block, and a context network, including a linear layer and a stack of Conformer blocks. In some implementations, the convolution subsampling block has two two-dimensional-convolution layers, both with strides (2, 2), resulting in a 4× reduction in the feature sequence length. The convolution subsampling block receives, as input, a sequence of input features/vectors (e.g., mel-frequency spectrograms such as the acoustic frames 110 of FIG. 1) associated with each transcribed non-synthetic speech utterance 304, and generates, as output, for each of a plurality of output steps, an encoded audio representation (eₛᵤₚ) 314 as output.

The CTC decoder 350 may include a phoneme decoder configured to decode a sequence of phonemes, a word piece decoder configured to decode a sequence of word pieces, or a grapheme decoder configured to decode a sequence of graphemes. The CTC decoder 350 receives, as input, each encoded audio representation 324 output from the encoder 210 and generates, as output, a probability distribution 394 over possible non-synthetic speech recognition hypotheses for the corresponding transcribed non-synthetic speech utterance 304 at the corresponding time step. In some examples, the probability distribution 394 over possible non-synthetic speech recognition hypotheses includes the one of possible phoneme labels, the possible word piece labels, or the possible grapheme labels. Thereafter, a supervised loss module 340 may determine a non-synthetic speech loss term 344 based on the probability distribution 394 over possible non-synthetic speech recognition hypotheses and the corresponding transcription 320 paired with the transcribed non-synthetic speech utterance 304. Here, the corresponding transcription 320 serves as a ground-truth transcription and may include a sequence of target phonemes, target word pieces, and/or target graphemes. The supervised training part 300a may train the USM CTC model on the non-synthetic speech loss term 344 by updating parameters of the audio encoder 210 (and optionally the CTC decoder 350) using the non-synthetic speech loss term 344.

Referring to FIG. 3B, the label prediction part 300b of the training initialization process 300 uses the trained USM CTC model 301 from the supervised training part 301 to predict pseudo ground-truth labels 420 for all of the speech utterances in the corpus of transcribed non-synthetic speech utterances 304 and the corpus of un-transcribed non-synthetic speech utterances 306. Notably, while the transcribed non-synthetic speech utterances each include the corresponding transcription 320, the pseudo ground-truth labels 420 predicted by the trained USM CTC model 301 for the transcribed non-synthetic speech utterances 304 will replace the corresponding transcriptions 320 during the training process 400 (FIG. 4) for training the USM RNN-T model 200

For each corresponding transcribed non-synthetic speech utterance 304 and each corresponding un-transcribed non-synthetic speech utterance 306, the audio encoder 210 receives, as input, a sequence of input features/vectors (e.g., mel-frequency spectrograms such as the acoustic frames 110 of FIG. 1) associated with the corresponding transcribed non-synthetic speech utterance 304 or the corresponding un-transcribed non-synthetic speech utterance 304, and generates, as output, for each of a plurality of output steps, an encoded audio representation (exup) 314 as output. The CTC decoder 350 including the phoneme decoder, the word piece decoder, or the grapheme decoder receives, as input, the encoded audio representations 324 output from the encoder 210 and generates, as output, a corresponding pseudo ground-truth label 420 for the corresponding transcribed non-synthetic speech utterance 304 or the corresponding un-transcribed non-synthetic speech utterance 306. Each transcribed non-synthetic speech utterance 304 may be paired with the corresponding pseudo ground-truth label 420 and each un-transcribed non-synthetic speech utterance 306 may be paired with the corresponding pseudo ground-truth label 420 to form a plurality of multilingual supervised training samples 402 (FIG. 4).

After the label prediction part 300b of the training initialization process 300 predicts the pseudo ground-truth labels 420 for the transcribed and un-transcribed non-synthetic speech utterances 304, 306 to form the supervised multilingual training utterance set 402, FIG. 4 shows a training process 400 for training, using quantization aware training, the USM RNN-T model 200 on the plurality of supervised training samples 402, 402a-n to learn how to transcribe spoken utterances. The number of training samples 402 in the plurality of supervised training samples 402 may be equal to a sum of the number of transcribed non-synthetic speech utterances 304 and the number of un-transcribed non-synthetic speech utterances 304. Here, each training sample 402 includes audio data 404 characterizing a corresponding one of the transcribed non-synthetic speech utterances 304 or the un-transcribed non-synthetic speech utterance 306 and the corresponding pseudo ground-truth labels 420 predicted for the corresponding one of the transcribed non-synthetic speech utterances 304 or the un-transcribed non-synthetic speech utterance 306. The pseudo ground-truth labels 420 corresponds to a transcription of the corresponding speech utterance 304, 306.

A model trainer 150 running on the remote computing system 60 may execute the training process 400 for training the ASR model 200 (e.g., USM RNN-T model 200) on the plurality of multilingual supervised training samples 402 while using quantization aware training and optionally weights only binarization to compress the size of the resulting ASR model 200. For each training sample 402, the ASR model 200 processes the corresponding audio data 404 to predict corresponding speech recognition results 252 and a loss module 260 generates a corresponding training loss 270 based on the speech recognition results 252 and the corresponding pseudo ground-truth labels 420. As the ASR model 200 includes the RNN-T decoder, the training loss 270 includes an RNN-T loss. During the training process 400 to train the ASR model 200, the model trainer 150 applies varies quantization aware training (QAT) 160 techniques for reducing model size yet maintaining acceptable WER degradation.

The audio encoder 210 of the ASR model 200 includes a plurality of weights and the training process 400 performs QAT 160 by quantizing each weight of the plurality of weights of the encoder based on an integer with a fixed-bit weight width. The QAT 160 may quantize weights of linear and projection attention layers in the audio encoder 210. The QAT 160 may not quantize convolution layers in the audio encoder 210 and layers of the RNN-T decoder 250 since their size in negligible in comparison to that of the audio encoder. Accordingly, the convolution layers in the audio encoder 210 and the layers of the RNN-T decoder 250 retain their original float value.

In some examples, the trained ASR model 200 is quantized using per-channel asymmetrical quantization with scale backpropagation to provide the ASR model 200 with 2-bits weight quantization. The training procedure may include 270,000 training iterations over 1.7 days Here, the resulting ASR model 200 with 2-bits weight quantization has a 1.4% WER degradation and a model size reduced down to 8.8% from its float baseline compared to the USM CTC model trained by combining quantization and sparsity suffering a 3× WER degradation. It can be hypothesized that the lower accuracy of the USM CTC model can be attributed to its four-stage training procedure.

In some additional examples, the trained ASR model 200 is quantized using per-channel asymmetrical quantization with scale backpropagation, clipping, and sub-channel split to provide the ASR model 200 with 2-bits weight quantization. The training procedure may include 270,000 training iterations over 1.7 days. Here, the resulting ASR model 200 with 2-bits weight quantization has a model size reduced down to 12.6% from its float baseline due to additional meta data attributed to its block size equal to 64.

With the addition of binarization, the QAT 160 may provide trained ASR models 200 (i.e., USM RNN-T model 200) with 1-bit weight quantization. The training procedures applying different binarization techniques require 446,000 training iterations over 3 4 days. For instance, the QAT 160 may quantize the trained ASR model using absolute max binarization to provide the ASR model 200 with 1-bit weight quantization. However, applying absolute max binarization as a binarization technique for quantizing the trained ASR model 200 results in the model diverging and resulting in 100% WER. It can be hypothesized that absolute max binarization causes the model to diverge due to the scale coefficient being defined by max value of absolute weights.

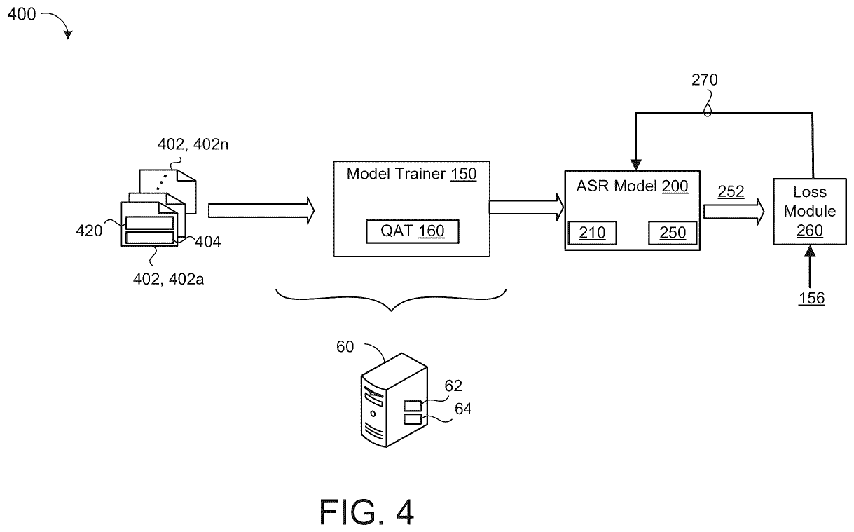

In some implementations, the use of absolute mean binarization is applied for quantization to provide 1-bit weight quantization without the resulting ASR model 200 diverging. One technique of applying absolute mean binarization may include subtracting a per-channel mean value from a plurality of weights of the trained ASR model (e.g, of the audio encoder 210) to provide a plurality of scaled weights and then binarizing the plurality of scaled weights to the target 1-bit weight quantization. FIG. 5 shows an example algorithm 500 this technique of applying absolute mean binarization. The algorithm centralized weights x by subtracting per channel mean value (in line 7) and then binarizing the weights x (line 14). Notably, all zeros are set equal to a small epsilon number (line 13 such that a sign function returns only 1 and −1. Weights centralization is not applied.

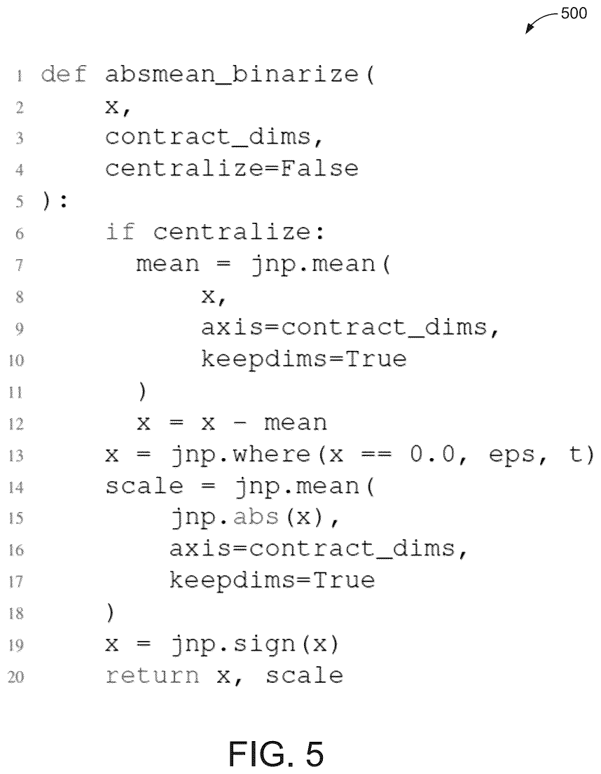

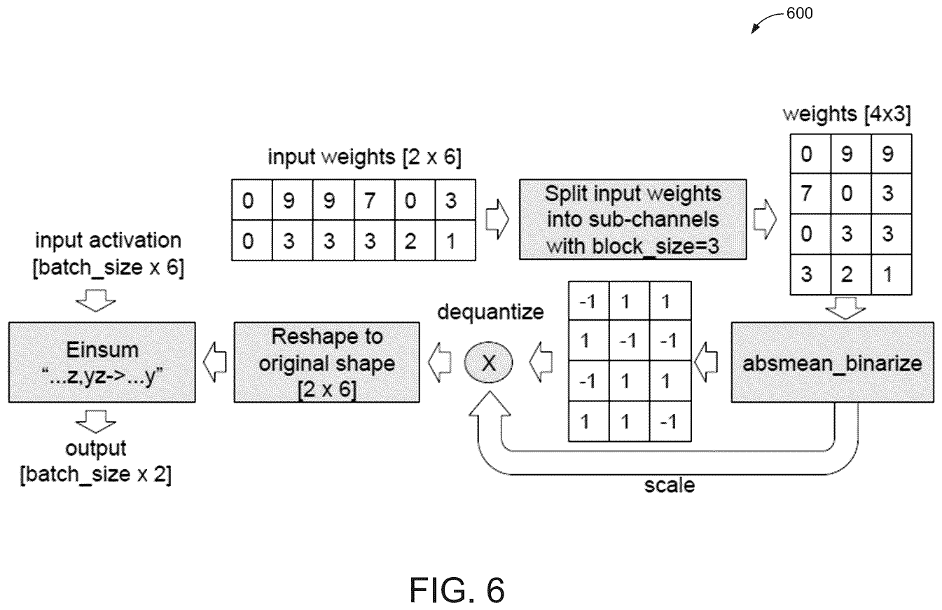

In another technique, the QAT 160 combines absolute mean binarization with sub-channel quantization, which includes a predefined blocks size having a value equal to 64. FIG. 6 shows a schematic view 600 of an example of the training process 400 applying the combination of sub-channel split with absolute mean binarization. Here, a plurality of input weights of the trained ASR model 200 have a shape of [2×6] and the training process 400 increases a number of channels in the plurality of input weights by splitting the plurality of weights into sub-channels. The sub-channels may have a block size equal to a value of 3, thereby resulting in the weight shape changing to [4×3]. The block size of the sub-channels can be set to values other than 3 without departing from the scope of the present disclosure. Thereafter, the training process subtracts a per sub-channel mean value from the plurality of input weights to provide a plurality of scaled weights and binarizes the plurality of scaled weights. Using fake QAT, the training process 400 then de-quantizes the binarized scaled weights by multiplying the binarized scaled weights by a scaling factor to provide de-quantized weights. Afterwords, the de-quantized weights are reshaped back to the original weight shape of [2×6] before the training process 400 computes an einsum over an input activation applied to the re-shaped de-quantized weights to quantize the trained ASR model 200 to the 1-bit weight quantization. Notably, the de-quantization step of multiplying the binarized scaled weights by the scaling factor is done on the einsum output, thereby causing the input activation to be reshaped to match a shape of the binarized weights, e.g., the shape of [4×3]. The trained ASR model 200 with 1-bit weight quantization resulting from the combined absolute mean binarization with sub-channel quantization technique achieves model size reduced down to 6.2% and only a mean WER degradation of 1.9% compared to its float baseline.

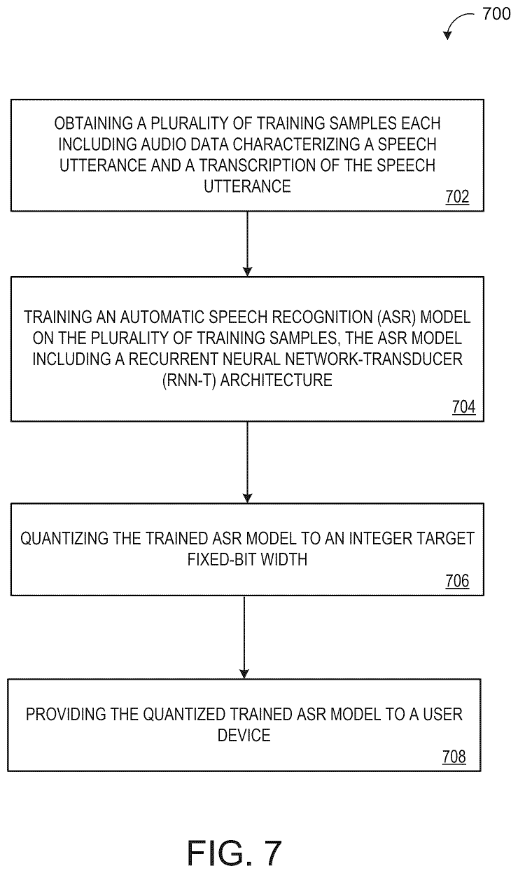

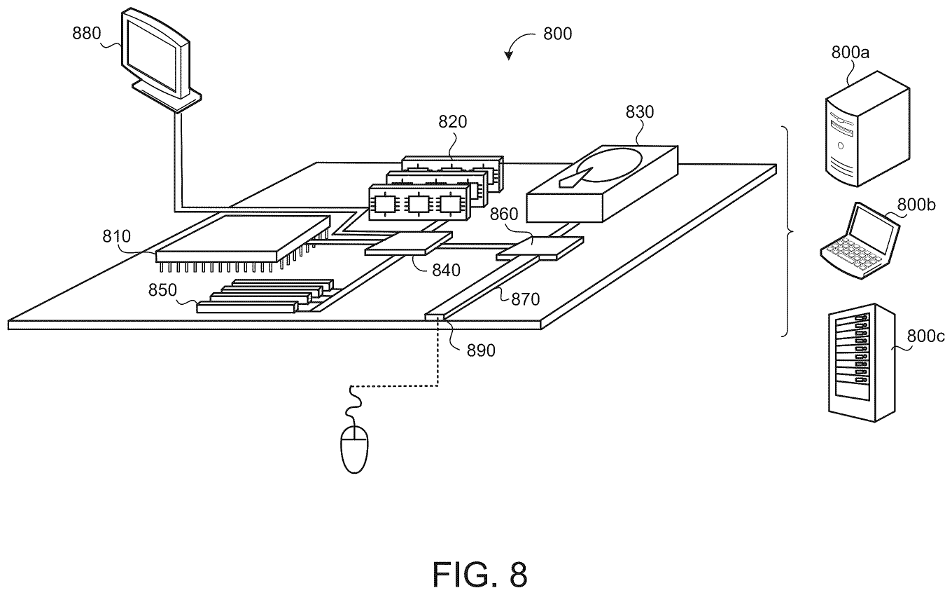

FIG. 7 is a flowchart of an exemplary arrangement of operations for a method 700 of training and quantizing an automated speech recognition (ASR) model 200 having a recurrent neural network-transducer (RNN-T) architecture. The method 700 may execute on data processing hardware 810 (FIG. 8) based on instructions stored on memory hardware 820 (FIG. 8). The data processing hardware 810 may include the data processing hardware 62 of the remote computing system 60 and the memory hardware 820 may include the memory hardware 64 of the remote computing system 60.

At operation 702, the method 700 includes obtaining a plurality of training samples 402 that each include audio data characterizing a corresponding speech utterance 304, 306 and a transcription 420 of the corresponding speech utterance 304, 306. The transcription 420 corresponds to pseudo ground-truth labels. At operation 704, the method 700 includes training the ASR model 200 on the plurality of training samples 402. Here, supervised training is applied where the ASR model 200 is trained to learn how to predict the pseudo ground-truth labels for the corresponding speech utterances 304, 306 characterized by the audio data 404.

At operation 706, the method 700 includes quantizing the trained ASR model to an integer target fixed-bit width. In some examples, the target fixed-bit width is equal to 2-bits. In other examples, the target fixed-bit width is equal to 1-bit. At operation 708, the method 700 includes providing the quantized trained ASR model to a user device 10. The user device 10 may execute the trained ASR model 200 having a compressed size from the quantization aware training such that the ASR model 200 may perform speech recognition on the user device 10. Additionally or alternatively, the trained ASR model 20 may execute on a remote computing device in communication with the user device 10 for performing speech recognition on spoken utterances captured by the user device 10 and communicated to the remote computing device.

FIG. 8 is a schematic view of an example computing device 800 that may be used to implement the systems and methods described in this document. The computing device 800 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 800 includes a processor 810, memory 820, a storage device 830, a high-speed interface/controller 840 connecting to the memory 820 and high-speed expansion ports 850, and a low speed interface/controller 860 connecting to a low speed bus 870 and a storage device 830. Each of the components 810, 820, 830, 840, 850, and 860, are interconnected using various busses, and may be mounted on a common motherboard or in other manners as appropriate. The processor 810 can process instructions for execution within the computing device 800, including instructions stored in the memory 820 or on the storage device 830 to display graphical information for a graphical user interface (GUI) on an external input/output device, such as display 880 coupled to high speed interface 840. In other implementations, multiple processors and/or multiple buses may be used, as appropriate, along with multiple memories and types of memory. Also, multiple computing devices 800 may be connected, with each device providing portions of the necessary operations (e.g., as a server bank, a group of blade servers, or a multi-processor system).

The memory 820 stores information non-transitorily within the computing device 800. The memory 820 may be a computer-readable medium, a volatile memory unit(s), or non-volatile memory unit(s). The non-transitory memory 820 may be physical devices used to store programs (e.g., sequences of instructions) or data (e.g., program state information) on a temporary or permanent basis for use by the computing device 800. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 830 is capable of providing mass storage for the computing device 800. In some implementations, the storage device 830 is a computer-readable medium. In various different implementations, the storage device 830 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier The computer program product contains instructions that, when executed, perform one or more methods, such as those described above. The information carrier is a computer-or machine-readable medium, such as the memory 820, the storage device 830, or memory on processor 810.

The high speed controller 840 manages bandwidth-intensive operations for the computing device 800, while the low speed controller 860 manages lower bandwidth-intensive operations. Such allocation of duties is exemplary only. In some implementations, the high-speed controller 840 is coupled to the memory 820, the display 880 (e.g., through a graphics processor or accelerator), and to the high-speed expansion ports 850, which may accept various expansion cards (not shown). In some implementations, the low-speed controller 860 is coupled to the storage device 830 and a low-speed expansion port 890. The low-speed expansion port 890, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 800a or multiple times in a group of such servers 800a, as a laptop computer 800b, or as part of a rack server system 800c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks, magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed on data processing hardware that causes the data processing hardware to perform operations comprising:
obtaining a plurality of training samples, each respective training sample of the plurality of training samples comprising:
audio data characterizing a corresponding speech utterance; and
a transcription of the corresponding speech utterance;
training an automatic speech recognition (ASR) model on the plurality of training samples, the ASR model comprising a recurrent neural network-transducer (RNN-T) architecture;
quantizing the trained ASR model to an integer target fixed-bit width; and
providing the quantized trained ASR model to a user device.

2. The method of claim 1, wherein quantizing the trained ASR model comprises quantizing, using per-channel asymmetrical quantization with scale backpropagation, the trained ASR model to the target fixed-bit width, the target fixed-bit width equal to two.

3. The method of claim 1, wherein quantizing the trained ASR model comprises quantizing, using per-channel asymmetrical quantization with scale backpropagation, clipping, and sub-channel split, the trained ASR model to the target fixed-bit width, the target fixed-bit width equal to two.

4. The method of claim 1, wherein quantizing the trained ASR model comprises quantizing, using absolute max binarization, the trained ASR model to the target fixed-bit width, the target fixed-bit width equal to one.

5. The method of claim 1, wherein quantizing the trained ASR model comprises:
subtracting a per channel mean value from a plurality of weights of the trained ASR model to provide a plurality of scaled weights; and
binarizing the plurality scaled weights to the target fixed-bit width, the target fixed-bit width equal to one.

6. The method of claim 1, wherein quantizing the trained ASR model comprises:
increasing a number of channels in a plurality of input weights of the trained ASR. model by splitting the plurality of input weights into sub-channels;
subtracting a per sub-channel mean value from the plurality of input weights of the trained ASR model to provide a plurality of scaled weights;
binarizing the plurality of scaled weights;
de-quantizing, using fake quantization aware training, the binarized scaled weights by multiplying the binarized scaled weights by a scaling factor to provide de-quantized weights;
re-shaping the de-quantized weights to a same shape as a shape of the plurality of input weights; and
computing an einsum over an input activation applied to the re-shaped de-quantized weights to quantize the trained ASR model to the target fixed-bit width, the target fixed-bit width equal to one.

7. The method of claim 1, wherein obtaining the plurality of training samples comprises:
receiving training data comprising:
a corpus of transcribed non-synthetic speech utterances, each transcribed non-synthetic speech utterance paired with a corresponding transcription; and
a corpus of un-transcribed non-synthetic speech utterances, each un-transcribed non-synthetic speech utterance not paired with a corresponding transcription:
training a teacher ASR model on the corpus of transcribed non-synthetic speech utterances to teach the teacher ASR model to learn how to predict the corresponding transcriptions from the non-synthetic speech utterances; and
processing, using the trained teacher ASR model, the corpus of transcribed non-synthetic speech utterances and the corpus of un-transcribed non-synthetic speech utterances to predict corresponding pseudo ground-truth labels.

8. The method of claim 1, wherein the ASR model comprises an audio encoder and a decoder, the decoder comprising a prediction network and a joint network.

9. The method of claim 8, wherein quantizing the ASR model comprises quantizing the audio encoder and not quantizing the decoder.

10. The method of claim 8, wherein the audio encoder comprises a plurality of multi-headed self attention layers each comprising a multi-headed attention mechanism.

11. The method of claim 10, wherein the plurality of multi-headed self attention layers comprises conformer layers or transformer layers.

12. The method of claim 1, wherein:
the speech utterances and transcriptions of the plurality of training samples span multiple different languages; and
the trained ASR model comprises a multilingual ASR model.

13. A system comprising:
data processing hardware; and
memory hardware in communication with the data processing hardware, the memory hardware storing instructions that when executed on the data processing hardware cause the data processing hardware to perform operations comprising:
obtaining a plurality of training samples, each respective training sample of the plurality of training samples comprising:
audio data characterizing a corresponding speech utterance; and
a transcription of the corresponding speech utterance;
training an automatic speech recognition (ASR) model on the plurality of training samples, the ASR model comprising a recurrent neural network-transducer (RNN-T) architecture;
quantizing the trained ASR model to an integer target fixed-bit width; and
providing the quantized trained ASR model to a user device.

14. The system of claim 13, wherein quantizing the trained ASR model comprises quantizing, using per-channel asymmetrical quantization with scale backpropagation, the trained ASR model to the target fixed-bit width, the target fixed-bit width equal to two.

15. The system of claim 13, wherein quantizing the trained ASR model comprises quantizing, using per-channel asymmetrical quantization with scale backpropagation, clipping, and sub-channel split, the trained ASR model to the target fixed-bit width, the target fixed-bit width equal to two.

16. The system of claim 13, wherein quantizing the trained ASR model comprises quantizing, using absolute max binarization, the trained ASR model to the target fixed-bit width, the target fixed-bit width equal to one.

17. The system of claim 13, wherein quantizing the trained ASR model comprises:
subtracting a per channel mean value from a plurality of weights of the trained ASR model to provide a plurality of scaled weights; and
binarizing the plurality scaled weights to the target fixed-bit width, the target fixed-bit width equal to one.

18. The system of claim 13, wherein quantizing the trained ASR model comprises:
increasing a number of channels in a plurality of input weights of the trained ASR model by splitting the plurality of input weights into sub-channels;
subtracting a per sub-channel mean value from the plurality of input weights of the trained ASR model to provide a plurality of scaled weights;
binarizing the plurality of scaled weights;
de-quantizing, using fake quantization aware training, the binarized scaled weights by multiplying the binarized scaled weights by a scaling factor to provide de-quantized weights;
re-shaping the de-quantized weights to a same shape as a shape of the plurality of input weights; and
computing an einsum over an input activation applied to the re-shaped de-quantized weights to quantize the trained ASR model to the target fixed-bit width, the target fixed-bit width equal to one.

19. The system of claim 13, wherein obtaining the plurality of training samples comprises:
receiving training data comprising:
a corpus of transcribed non-synthetic speech utterances, each transcribed non-synthetic speech utterance paired with a corresponding transcription; and
a corpus of un-transcribed non-synthetic speech utterances, each un-transcribed non-synthetic speech utterance not paired with a corresponding transcription:
training a teacher ASR model on the corpus of transcribed non-synthetic speech utterances to teach the teacher ASR model to learn how to predict the corresponding transcriptions from the non-synthetic speech utterances; and
processing, using the trained teacher ASR model, the corpus of transcribed non-synthetic speech utterances and the corpus of un-transcribed non-synthetic speech utterances to predict corresponding pseudo ground-truth labels.

20. The system of claim 13, wherein the ASR model comprises an audio encoder and a decoder, the decoder comprising a prediction network and a joint network.

21. The system of claim 20, wherein quantizing the ASR model comprises quantizing the audio encoder and not quantizing the decoder.

22. The system of claim 20, wherein the audio encoder comprises a plurality of multi-headed self attention layers each comprising a multi-headed attention mechanism.

23. The system of claim 22, wherein the plurality of multi-headed self attention layers comprises conformer layers or transformer layers.

24. The system of claim 13, wherein:
the speech utterances and transcriptions of the plurality of training samples span multiple different languages; and
the trained ASR model comprises a multilingual ASR model.
